(19) United States
(12) Patent Application Publication
(10) Pub. No.: US 2010/0287845 A1
(43) Pub. Date: Nov. 18, 2010

(54) POLYCRYSTALLINE DIAMOND COMPOSITES

(76) Inventors: Charles Stephan Montross, Nuffield Springs (ZA); Humphrey Sithebe, Nuffield Springs (ZA)

Correspondence Address: FROMMER LAWRENCE & HAUG, 745 FIFTH AVENUE- 10TH FL., NEW YORK, NY, 10151, US

(21) Appl. No.: 12/663,617

(22) PCT Filed: Aug. 29, 2008
(86) PCT No.: PCT/IB08/53514

§ 371 Date: Apr. 20, 2010

(30) Foreign Application Priority Data
Aug. 31, 2007 (ZA) 2007/07467

(51) Int. Cl. C09K 3/14

(52) U.S. Cl. 51/307

(57) ABSTRACT

The invention is for a polycrystalfine diamond composite material comprising intergrown diamond particles and a binder phase, the binder phase comprising a tin-based intermetallic or ternary carbide compound formed with a metallic solvent/catalyst. The invention extends to a polycrystalline diamond abrasive compact comprising such a composite material and to a tool insert comprising such a diamond abrasive compact.

### BACKGROUND OF THE INVENTION

This invention relates to polycrystalline diamond (PCD) composite materials having improved thermal stability.

Polycrystalline diamond (PCD) is used extensively in tools for cutting, milling, grinding, drilling and other abrasive operations due its high abrasion resistance and strength. In particular, it may find use within shear cutting elements included in drilling bits used for subterranean drilling.

A commonly used tool containing a PCD composite abrasive compact is one that comprises a layer of PCD bonded to a substrate. The diamond particle content of these layers is typically high and there is generally an extensive amount of direct diamond-to-diamond bonding or contact. Diamond compacts are generally sintered under elevated temperature and pressure conditions at which the diamond particles are crystallographically or thermodynamically stable.

Examples of composite abrasive compacts can be found described in U.S. Pat. Nos. 3,745,623; 3,767,371 and 3,743,489.

The PCD layer of this type of abrasive compact will typically contain a catalyst/solvent or binder phase in addition to the diamond particles. This typically takes the form of a metal binder matrix which is intermingled with the intergrown network of particulate diamond material. The matrix usually comprises a metal exhibiting catalytic or solvating activity towards carbon such as cobalt, nickel, iron or an alloy containing one or more such metals.

PCD composite abrasive compacts are generally produced by forming an unbonded assembly of the diamond particles and solvent/catalyst, sintering or binder aid material on a cemented carbide substrate. This unbonded assembly is then placed in a reaction capsule which is then placed in the reaction zone of a conventional high pressure/high temperature apparatus. The contents of the reaction capsule are then subjected to suitable conditions of elevated temperature and pressure to enable sintering of the overall structure to occur.

It is common practice to rely at least partially on binder originating from the cemented carbide substrate as a source of metallic binder material for the sintered polycrystalline diamond. In many cases, however, additional metal binder powder is admixed with the diamond powder before sintering. This binder phase metal then functions as the liquid-phase medium for promoting the sintering of the diamond portion under the imposed sintering conditions.

The preferred solvent/catalysts or binder systems used to form PCD materials characterised by diamond-to-diamond bonding, which include Group VIIIA elements such as Co, Ni, Fe, and also metals such as Mn, are largely due to the high carbon solubility of these elements when molten. This allows some of the diamond material to dissolve and reprecipitate again as diamond, hence forming intercrystalline diamond bonding while in the diamond thermodynamic stability regime (at high temperature and high pressure). This intercrystalline diamond-to-diamond bonding is desirable because of the resulting high strength and wear resistance of the PCD materials.

The unfortunate result of using solvent/catalysts such as Co as a solvent/catalyst is a process known in the literature as thermal degradation. This degradation occurs when the PCD material is subjected to temperatures typically greater than 700° C. either under tool application or tool formation conditions. This temperature is severely limiting in the application of PCD materials such as for rock drilling or machining of materials.

The thermal degradation of PCD materials is postulated to occur via two mechanisms:
The first results from differences in the thermal expansion coefficients of the metallic solvent/catalyst binder and the intergrown diamond. This differential expansion at elevated temperature can cause micro-cracking of the intergrown diamond. It may become of particular concern even at temperatures exceeding 400° C.
The second is due to the inherent activity of the metallic solvent/catalyst in a carbon system. The metallic binder begins converting the diamond to non-diamond carbon when heated above approximately 700° C. At low pressures i.e. in the graphite stability regime, this results in the formation of non-diamond carbon, in particular graphitic carbon, the formation of which will ultimately cause bulk degradation of mechanical properties, leading to catastrophic mechanical failure.

One of the earliest methods of addressing this thermal degradation problem was disclosed in U.S. Pat. No. 4,224,380 and again in U.S. Pat. No. 6,544,308, comprising the removal of the solvent/catalyst through leaching by acids or electrochemical methods, which resulted in a porous PCD material that showed an improvement in the thermal stability. However, this resultant porosity caused a degradation of the mechanical properties of the PCD material. In addition, the leaching process is unable completely to remove isolated solvent/catalyst pools that are fully enclosed by intercrystalline diamond bonding. Therefore, the leaching approach is believed to result in a compromise in properties.

A further method for addressing the thermal degradation problem involves the use of non-metallic or non catalyst/solvent binder systems. This is achieved, for example, through infiltration of the diamond compact with molten silicon or eutectiferous silicon which then reacts with some of the diamond to form a silicon carbide binder in situ, as taught in U.S. Pat. Nos. 3,239,321; 4,151,686; 4,124,401; and 4,380,471, and also in U.S. Pat. No. 5,010,043 using lower pressures. This SiC-bonded diamond shows a clear improvement in thermal stability, capable of sustaining temperatures as high as 1200° C. for several hours as compared with PCD materials made using solvent/catalysts which cannot tolerate temperatures above 700° C. for any appreciable length of time. However, there is no diamond-to-diamond bonding in SiC bonded diamond compacts. Hence the strength of these materials is limited by the strength of the SiC matrix, which results in materials of reduced strength and wear resistance.

Other methods of addressing the thermal degradation problem are taught by U.S. Pat. Nos. 3,929,432; 4,142,869 and 5,011,514. Here, the surface of the diamond powder is first reacted with a carbide-former such as tungsten or a Group IVA metal; and then the interstices between the coated diamond grit are filled with eutectic metal compositions such as silicides or copper alloys. Again, although thermal stability of the diamond is improved, there is no diamond-to-diamond bonding and the strength of this material is limited by the strength of the metal alloy matrix.

Another approach taken is to attempt to modify the behaviour of standard solvent/catalysts in situ. U.S. Pat. No. 4,288,248 teaches the reaction of solvent/catalysts such as Fe, Ni, and Co with Cr, Mn, Ta, and AI to form intermetallic compounds. Similarly, in U.S. Pat. No. 4,610,699, standard metal catalysts are reacted with Group IV, V, VI metals in the diamond stability zone resulting in the formation of unspecified intermetallics. However, the formation of these intermetallic compounds within the catalyst interferes with diamond intergrowth and hence adversely affects material strength.

A more recent teaching using intermetallic compounds to provide thermal stability but still achieve high strength materials through diamond intergrowth is discussed in US Patent Application US2005/0230156. This patent application discusses the necessity of coating the diamond grit with the cobalt catalyst to allow polycrystalline diamond intergrowth before interacting with admixed intermetallic forming compounds. After the desired diamond intergrowth, it is postulated that the cobalt catalyst will then form an intermetallic which renders it non-reactive with the intergrown diamond.

In an exemplary embodiment of this patent application, silicon is admixed with the cobalt-coated diamond with the intention of protectively forming cobalt silicide in the binder after the desired diamond intergrowth occurs. Practically, however, it is well-known that silicon compounds will melt at lower temperatures than the cobalt coating, resulting in a first reaction between the cobalt and silicon before diamond intergrowth can occur in the presence of molten cobalt. Additionally, experimental results have shown that these cobalt silicides are not able to facilitate diamond intergrowth, even under conditions where they are molten. Further admixed intermetallic-forming compounds identified in this patent application are also known to form eutectics with melting temperatures below that of the cobalt coating. The end result is therefore that appreciable quantities of the intermetallic compounds form before diamond intergrowth can occur, which results in weak PCD materials due to reduced/no intergrowth.

Certain other types of intermetallics such as the stannides have also been used in diamond systems. U.S. Pat. Nos. 3,372,010; 3,999,962; 4,024,675; 4,184,853; 4,362,535; 5,096,465; 5,846,269 and 5,914,156 disclose the use of certain stannide intermetallics (such as Ni₃Sn₂ and Co₃Sn₂) in the production of grit-containing abrasive tools. However, these are not sintered under HpHT conditions, so no diamond intergrowth can be anticipated.

U.S. Pat. Nos. 4,439,237 and 6,192,875 disclose metallurgically-bonded diamond-metal composites that comprise a Ni and/or Co base with a Sn, Sb, or Zn-based intermetallic compound dispersed therein. However, these are also not sintered under HpHT conditions, so no diamond intergrowth can be expected.

U.S. Pat. No. 4,518,659 discloses an HpHT process for the manufacture of diamond-based composites where certain molten non-catalyst metals (such as Cu, Sn, Al, Zn, Mg and Sb) are used in a pre-infiltration sweepthrough of the diamond powder in order to facilitate optimal catalytic behaviour of the solvent/catalyst metal. Here, although low levels of residual non-catalyst presence are anticipated to remain within the PCD body, these are not anticipated to be in sufficient quantities to result in significant intermetallic formation.

The problem addressed by the present invention is therefore the identification of a solvent/catalyst metallic binder that allows diamond intergrowth under diamond synthesis conditions to form intergrown PCD, but which does not cause thermal degradation when the resultant PCD is used at elevated temperatures (above 700° C.) under ambient pressure conditions.

### SUMMARY OF THE INVENTION

According to the invention, a polycrystalline diamond composite material comprises intergrown diamond particles and a binder phase, the binder phase comprising a tin-based intermetallic or ternary carbide compound formed with a metallic solvent/catalyst.

The binder phase may additionally contain both free (unreacted) solvent/catalyst and a further carbide formed with Cr, V, Nb, Ta and/or Ti.

The intermetallic compound preferably comprises at least 40 volume %, more preferably at least 50 volume %, of the binder phase.

### BRIEF DESCRIPTION OF THE FIGURES

The invention will now be described in more detail, by way of example only, with reference to the accompanying figures in which:

FIG. 1 is a binary phase diagram for a simple Co—Sn system illustrating various anticipated Co—Sn intermetallics;

FIG. 2 is a ternary phase diagram for a Co—Sn—C system illustrating, in addition to the formation of various intermetallics, the formation of a ternary carbide incorporated into a preferred embodiment of a diamond composite material of the invention; and

FIG. 3 is a high magnification scanning electron micrograph of a preferred embodiment of a PCD composite material of the invention.

### DETAILED DESCRIPTION OF PREFERRED EMBODIMENTS

The present invention is directed to a PCD material with a complex solvent/catalyst binder system. The binder system contains tin-based intermetallic and/or ternary carbide compounds formed by reaction with solvent/catalyst metal that significantly enhances the thermal stability of the PCD material. These compounds provide or enhance thermal stability of the PCD (due to a low difference in thermal expansion coefficients with diamond) and also have no reaction with diamond under elevated temperatures (>700° C.) at low or ambient pressure. The same compounds will, in the liquid state, additionally facilitate diamond intergrowth by allowing diamond/carbon dissolution.

The metal solvent/catalyst-based binder phase will therefore contain a tin-based intermetallic or ternary carbide compound that preferably comprises at least 40 volume %, more preferably at least 50 volume %, of the binder phase. It may additionally contain a further carbide-forming element from the group consisting of Cr, V, Nb, Ta and Ti; such that the resultant carbide will be no more than 50 volume % of the binder phase.

The intermetallic compound is typically formed through the interaction of Sn and a conventional solvent/catalyst metal. The reaction may be complete i.e. the solvent/catalyst is fully consumed in the reaction, or there may remain behind unreacted solvent/catalyst up to about 60 volume %, more preferably up to about 50 volume %, in the binder phase. Both stoichiometric and nonstoichiometric intermetallic and ternary carbide compounds have been found to result in improved properties in this invention.

Excess binder content can result in a reduction of the diamond-to-diamond bonding, since too large a volume of binder may prevent suitable inter-particle diamond contact. Therefore, the optimal volume fraction of the binder should typically be no more than 20 volume %. It is anticipated that lower volume fractions of the intermetallic-based binder will require longer sintering times in order to allow sufficient mass transport for effective diamond intergrowth.

A preferred embodiment of the invention is one in which the tin forms intermetallic compounds primarily with Co and Ni. These Sn-based binder systems may additionally be enhanced through the additions of Fe, Cr, Mo, Mn, V, Nb, Ti, Zr, Hf and Ta. The Sn-based intermetallics have been found to facilitate diamond intergrowth at HpHT. PCD compacts with Sn-based intermetallic binders are additionally observed to be thermally stable.

A typical suitable Sn-based, thermally stable binder is the intermetallic CoSn with a peritectic melting temperature of around 936° C. at ambient pressure. When sufficiently above the melting point of the intermetallic at HpHT, diamond intergrowth occurs. However, it has been found that certain intermetallic species may require higher p,T conditions in order to operate effectively as diamond sintering aids. This has been ascribed to melting point limitations. For example, of two intermetallic species occurring in the Co—Sn system, CoSn (atmospheric pressure melting point of 936° C.) and Co₃Sn₂ (atmospheric melting point of 1170° C.), only CoSn has been found to facilitate PCD sintering at standard HpHT conditions, where temperatures are typically between about 1300 and 1450° C. and pressures between 50 and 58 kbar. Given the typical effect of pressure in significantly increasing melting points, it is likely that whilst CoSn is molten under HpHT conditions, Co₃Sn₂ is not, or at least is insufficiently so. (One theory of melting behaviour predicts that a significant temperature excursion must be made above the melting point of a compound in order to disrupt its structure sufficiently to achieve the solution/diffusion properties of the melt.) Hence it may be hypothesised that the structure of the Co₃Sn₂ persists sufficiently in this case to prevent the carbon diffusion and association required to effect sintering. Therefore, whilst other suitable Sn-based binders may include the intermetallics such as Ni₃Sn₂ and Co₃Sn₂ (with ambient pressure congruent melting points of around 1275° C. and 1173° C., respectively, that in the diamond stability region at high pressures will increase with the increased pressure), it may be necessary to raise the synthesis temperature in order to facilitate diamond intergrowth.

It has been further observed that the formation of certain intermetallic-based ternary carbides can also be highly desirable. For example, the formation of Co₃SnC compounds in the Co—Sn system has been found to be highly advantageous in increasing the degree of diamond intergrowth that can be achieved for a given HpHT condition.

Currently, the most effective means for providing for maximised formation of desirable phases lies in selecting the correct composition with respect to the Sn and solvent/catalyst metal. The Co—Sn system will be used to illustrate this principle.

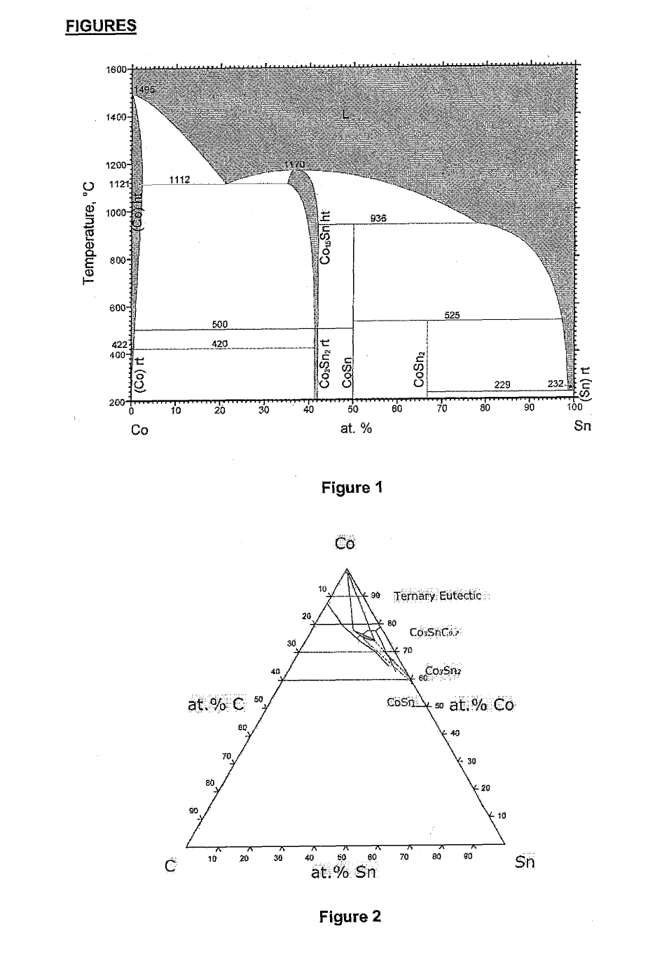

Referring to accompanying FIG. 1, there is shown a binary phase diagram for the simple Co—Sn system that shows the various Co—Sn intermetallics anticipated over the full range 100% Co to 100% Sn. There are three base intermetallic species typically observed, namely:

| | |
|---|---|
| CoSn₂ | with an atomic Co:Sn ratio of 1:2 |
| CoSn | with an atomic Co:Sn ratio of 1:1 |
| Co₃Sn₂ | with an atomic Co:Sn ratio of 3:2 |

According to standard metallurgical principles, maximising the formation of any one of these individual intermetallics can be achieved simply through selection of the appropriate Co:Sn ratio window (and appropriate temperature conditions, according to the phase lines shown).

Referring now to accompanying FIG. 2, the more complex ternary phase diagram for the Co—Sn—C system shows the formation of two of these same base intermetallics, and the further presence of the ternary carbide, namely

| | |
|---|---|
| CoSn | with an atomic Co:Sn ratio of 1:1 |
| Co₃Sn₂ | with an atomic Co:Sn ratio of 3:2 |
| Co₃SnC_{0.7} | with an atomic Co:Sn ratio of 3:1 |

As for the binary phase mixture, by selecting the appropriate Co:Sn ratio window, it is possible preferentially to bias the metallurgy towards one particular compound.

For certain Co—Sn systems relevant to diamond sintering, i.e. in the presence of excess carbon, where the maximum amount of the ternary carbide (Co₃SnC_{0.7}) may be desired, the ratio of Co:Sn should therefore be as close as possible to 3:1; in other words, this optimised composition for the Co—Sn—C system lies at close to 75 atomic % Co and 25 atomic % Sn. It has been found that where the composition tends to be:
Sn-rich from this ratio (i.e. more than 25 atomic % Sn), then this will tend to lead to increasing amounts of Co₃Sn₂ formation. (Specifically in the Co—Sn system for PCD sintering, the formation of this intermetallic species has been found to be less desirable in terms of achieving an optimally sintered PCD end-product at standard HpHT conditions);
Co-rich from this ratio (i.e. more than 75 atomic % Co), then the final diamond product tends to become less thermally stable, as the amount of “free” cobalt (i.e. which is not tied up in thermally stable compounds) increases. In practise, it has been found that there is a significant degree of flexibility in this latter threshold for Co—Sn, such that a significant degree of free cobalt can be accommodated before substantial thermal degradation effects are observed in the final product. As such for the Co—Sn system, it is preferred that where only a range window is practically achievable, then this focuses on the preferred composition (75:25 Co:Sn atomic) but may span the cobalt-rich portion of the compositional range.

By contrast, if an optimised composition exploiting the formation of the CoSn intermetallic species is desired, then the Co:Sn ratio should be as close as possible to 1:1 in order to maximise the amount of CoSn forming. Where the composition tends to be:
Sn-rich from this ratio (i.e more than 50 atomic %), then the intermetallic species CoSn₂ will also begin to form, hence undesirably reducing the amount of CoSn;
Co-rich from this ratio (i.e. more than 50 atomic %), then the co-formation of a less desirable intermetallic Co₃Sn₂ can reduce the catalytic efficacy of the binder system at standard HpHT conditions.

The exemplary compositional ranges discussed above are specific to the Co—Sn system in terms of the sensitivities to the formation of less desirable species. However, these observations can easily be extended to general principles for other suitable chemical systems.

To encourage diamond intergrowth to occur at industrially acceptable temperatures, the further addition of another carbide former, such as those listed above, including chromium, iron, and manganese, may be used.

Diamond composite materials of the invention are generated by sintering diamond powder in the presence of a suitable metallurgy under HpHT conditions. They may be generated through standalone sintering, i.e. there is no further component other than the diamond powder and binder system mixture, or they may be generated on a backing of suitable cemented carbide material. In the case of the latter, they will typically be infiltrated by additional catalyst/solvent source from the cemented carbide backing during the HpHT cycle.

The diamond powder employed may be natural or synthetic in origin and will typically have a multimodal particle size distribution. It has also been found that it is advantageous to ensure that the surface chemistry of the diamond powder has reduced oxygen content in order to ensure that the ternary carbide constituents do not oxidise excessively prior to formation of the PCD, reducing their effectiveness. Hence both the metal and diamond powders should be handled during the pre-sintering process with appropriate care, to ensure minimal oxygen contamination.

The tin-based binder metallurgy can be formed by several generic approaches, for example:
pre-reaction of the tin and solvent/catalyst, typically under vacuum at temperature, which is then either admixed or infiltrated into the diamond powder feedstock under HpHT conditions;
in situ reaction under HpHT sintering conditions, preferably using an intimate homogenous mixture of the required components, which are typically elemental. This may be provided within the diamond powder mixture or from an infiltration layer or bed adjacent to it, and may include the carbon component, or this may be sourced from the diamond powder;
a staged in situ reaction under HpHT sintering conditions using a mixture of tin and diamond powder and subsequent infiltration and in situ reaction with solvent/catalyst metal from an external infiltration source (which may be provided by a carbide backing substrate).

Suitable preparation technologies for introducing the tin-based intermetallics or ternary carbide species or precursors into the diamond powder mixture include powder admixing, thermal spraying, precipitation reactions, vapour deposition techniques etc. An infiltration source can also be prepared using methods such as tape casting, pre-alloying etc.

Using standard diamond synthesis conditions in the diamond stability regime, the peritectic composition of CoSn was found to be especially suitable for industrial production processes, since the typical sintering conditions used were sufficiently above the liquidus of the intermetallic. During standard diamond synthesis conditions, the temperature used should be sufficiently above the melting point of the intermetallic mixture, at the pressures used, to allow the diamond to dissolve and re-precipitate.

In order to evaluate the diamond composite materials of the invention, in addition to electron microscopy (SEM) and XRD analysis, thermal stability (ST), thermal wear behaviour application-based (milling), and wear application-based (turning) tests were used.

A thermal stability test is typically used as a research measure of the effective thermal stability of a standalone (i.e. unbacked) small, PCD sample. The suitably-sized sample to be tested is thermally stressed by heating under vacuum at ˜100° C./hour to 850° C., held at 850° C. for 2 hours, and then slowly cooled to room temperature. After cooling, Raman spectroscopy is conducted to detect the presence of graphitic carbon or non-sp³ carbon resulting from the thermal degradation of the diamond. This type of heat treatment is considered to be very harsh, where a commercially available Co-based PCD showed a significant graphite peak after such treatment. A reduced conversion of diamond to graphite is indicative of an increase in thermal stability of the material.

A thermal wear behaviour application-based test can be used as an indicator of the degree to which a PCD-based material will survive in a thermally demanding environment.

The test is conducted on a milling machine including a vertical spindle with a fly cutter milling head at an operatively lower end thereof. Rock, in particular granite, is milled by way of a dry, cyclic, high revolution milling method. The milling begins at an impact point where the granite is cut for a quarter of a revolution, the granite is then rubbed by the tool for a further quarter revolution and the tool is then cooled for half a revolution at which point the tool reaches the impact point. For an unbacked cutting tool, a shallow depth milling of the rock is carried out—typically a depth of cut of about 1 mm is used. For a backed tool, the depth of cut is increased, typically to about 2.5 mm.

The length of the rock that has been cut prior to failure of the tool is then measured, where a high value indicates further distance traveled and a good performance of the tool, and a lower value indicates poorer performance of the tool. As the test is a dry test, the failure of the tool is deemed to be thermally induced rather than abrasion induced. Hence this test is a measure of the degree to which the tool material will wear in a thermally stressed application.

A wear resistance application-based test can be used as an indicator of the overall wear resistance of a PCD-based material. Tests of this nature are well known in the art. It essentially involves wearing the tool continuously in a granite log turning set-up. The results are reported as a ratio between the volume of rock removed for the length of wear scar observed on the tool. A larger ratio indicates more rock removed for less tool wear i.e. a more wear resistant material.

The invention will now be described in more detail, by way of example only, with reference to the following non-limiting examples.

### EXAMPLES

### Example 1

### Unbacked PCD Samples Produced Using the Co—Sn System

A variety of samples of PCD sintered in the presence of a Co—Sn-based binder were prepared. Several mixtures of Co and Sn metal powders with a range of Co:Sn ratios were produced. For each sample, a bed of multimodal diamond powder of approximately 20 μm in average diamond grain size was then placed into a niobium metal canister and a layer of the metal powder mixture sufficient to provide a binder constituting 10 volume % of the diamond was placed onto this powder bed. The canister was then evacuated to remove air, sealed and treated under standard HpHT conditions at approximately 55 kbar and 1400° C. to sinter the PCD.

The sintered PCD compacts were then removed from the canister and examined using:
scanning electron microscopy (SEM) for evidence of intergrowth; and
XRD analysis to determine the phases present in the binder.

The results of this characterisation are summarised below in Table 1.

TABLE 1

| | | | | Projected |
|---|---|---|---|---|
| | | | Dominant Binder | melting point |
| | Co:Sn ratio | Diamond | phases present by | at HpHT |
| Sample | (atomic % Sn) | intergrowth | XRD | (° C.) |
| 1 | 1:1 (50% Sn) | Yes | CoSn | ca. 1200 |
| 2 | 3:2 (40% Sn) | Poor | Co₃Sn₂ | ca. 1420 |
| 3 | 3:1 (25% Sn) | Yes | Co₃Sn₂C_{0.7} | ca. 1380 |

It is evident from these results that there are at least two clear regions in the Co—Sn phase diagram where PCD can be sintered under standard HpHT conditions. These occur:
at or near the 1:1 Co:Sn ratio, where CoSn forms; and
at or near the 3:1 Co:Sn ratio, where Co₃SnC_{0.7} forms.

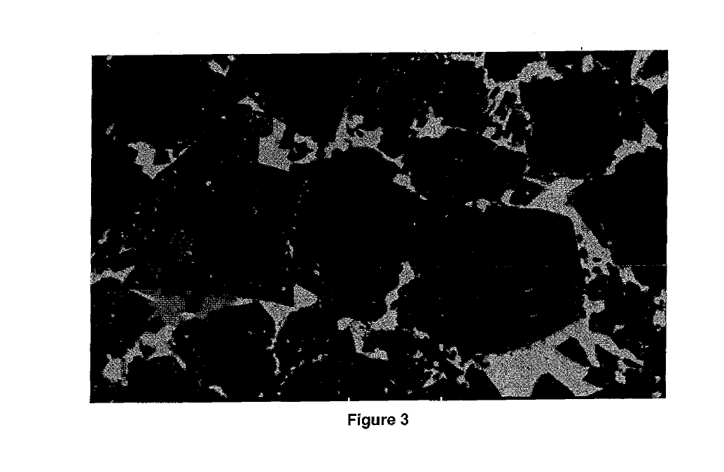

For example, referring to accompanying FIG. 3, an SEM micrograph of sample 1 shows clear evidence of intergrowth between adjacent diamond particles. It is also clear that in the case of higher melting point intermetallics, such as Co₃Sn₂, standard HpHT conditions appear insufficient to achieve good sintering.

A further observation made during this set of experiments was that pre-synthesis mixtures (of diamond and Co/Sn powders) were sensitive to certain levels of oxygen contamination such that increased oxygen tended to lead to an increase in the occurrence of non-target intermetallics and sub-optimally sintered materials.

The thermal stability of sample 3 was then compared to a standard Co-based PCD material in a thermal stability test as described above. Sample 3 showed a much reduced occurrence of graphitic carbon; such that the observed graphitisation was less than 30% that of the standard Co-sintered PCD.

### Example 2

### Carbide Substrate Backed PCD Samples Produced Using the Co—Sn System

Several samples of Co—Sn-based PCD sintered onto a cemented carbide substrate were prepared. In each case, tin powder was pre-reacted with cobalt metal powder to produce a CoSn alloy/intermetallic of specific atomic ratio 1:1. This pre-reacted source was then introduced into an unsintered diamond powder mass by either pre-synthesis admixing or in situ infiltration.

The 1:1 CoSn pre-reacted powder mixture was prepared by milling the Co and Sn powders together in a planetary ball mill. The powder mixture was then heat-treated in a vacuum furnace (600° C.-800° C.) to manufacture reacted CoSn material. This pre-reacted material was then further crushed/milled to break down agglomerates and reduce the particle size.

The diamond powder used was multimodal in character and had an average grain size of approximately 22 μm. A chosen amount of this CoSn material (expressed as a weight % of the diamond powder mass) was then brought into contact with the unsintered diamond powder within the HpHT reaction volume. This was either as a discrete powder layer adjacent to the diamond powder mass (which would infiltrate the diamond during HpHT after melting i.e. in situ infiltration) or the CoSn material was admixed directly into the diamond powder mixture before the canister was loaded.

The diamond powder/CoSn assembly was then placed adjacent a cemented carbide substrate such that the binder metallurgy was then further augmented by the infiltration of additional cobalt from the cemented carbide substrate at HpHT conditions. In this way, a range of Co:Sn ratio binder systems and resultant PCD materials was produced.

The thermal wear behaviour of each of these samples was then tested using an application-based milling test and turning test as described above.

The results for the range of samples produced in this set of experiments is summarised in Table 2. A Co-based PCD sample designated Cl, is included for comparative purposes.

| | Wt % CoSn | | Dominant | | |
|---|---|---|---|---|---|
| | pre- | | binder | Milling | |
| | reacted | Infiltrate/ | phases | test | Turning test |
| Sample | source | Admix | (XRD) | (mm) | (wear ratio) |
| 4 | 7.5 | admix | Co₃SnC_{0.7}; | 3198 | 0.130 |
| | | | Co | | |
| 5 | 15 | admix | Co₃SnC_{0.7}; | 1340 | 0.141 |
| | | | Co₃Sn₂ | | |
| 6 | 20 | infiltrate | Co₃SnC_{0.7}; | 5600 | 0.146 |
| | | | Co₃Sn₂ | | |
| | | | (very low) | | |
| C1 | Pure Co | — | Co | 1090 | 0.155 |

It is evident from these results that all of the CoSn-based materials outperform the standard Co-based PCD Cl in the application-based milling test. It is also evident that by optimising certain phases at the expense of others, the performance difference can be further enhanced.

A further critical observation that must be made that relates to the overall wear resistance of the material produced, as shown in the turning test, is that outside of thermal issues, the overall wear resistance of the CoSn-based materials appears to be slightly reduced when compared with that of standard Co-based PCD. This is not unsurprising given the experimental nature of the materials produced, which may yet be further optimised. However, this may also be indicative of the fact that although the CoSn system can be used to produce PCD materials of vastly increased thermal stability over standard PCD materials, this may be at some slight expense of total wear resistance.

1. A polycrystalline diamond composite material comprising intergrown diamond particles and a binder phase, the binder phase comprising a tin-based intermetallic or ternary carbide compound formed with a metallic solvent/catalyst.

2. A polycrystalline diamond composite material according to claim 1, wherein the metallic solvent/catalyst is selected from the group consisting of Co, Fe, Ni, and Mn.

3. A polycrystalline diamond composite material according to claim 1, wherein the metallic solvent/catalyst is Co or Ni.

4. A polycrystalline diamond composite material according to claim 1, wherein the binder phase further comprises free (unreacted) solvent/catalyst and/or a further carbide formed with Cr, V, Nb, Ta and/or Ti.

5. A polycrystalline diamond composite material according to claim 1, wherein the tin-based intermetallic or ternary carbide comprises at least 40 volume % of the binder phase.

6. A polycrystalline diamond composite material according to claim 1, wherein the tin-based intermetallic or ternary carbide comprises at least 50 volume % of the binder phase.

7. A polycrystalline diamond composite material according to claim 4, wherein any further carbide does not form more than 50 volume % of the binder phase.

8. A polycrystalline diamond composite material according to claim 1, wherein the binder phase comprises no more than 20% of the polycrystalline diamond composite material.

9. A polycrystalline diamond abrasive compact comprising a polycrystalline diamond composite material according to claim 1.

10. A tool comprising a polycrystalline diamond abrasive compact according to claim 9, capable for use in a cutting, milling, grinding, drilling or other abrasive application.
